(19) United States
(12) Patent Application Publication
(10) Pub. No.: US 2023/0088411 A1
(43) Pub. Date: Mar. 23, 2023

(54) MACHINE READING COMPREHENSION APPARATUS AND METHOD

(71) Applicant: INSTITUTE FOR INFORMATION INDUSTRY, TAIPEI (TW)

(72) Inventors: Yu-Shian CHIU, Taipei (TW); Wei-Jen YANG, Taipei (TW); Guann-Long CHIOU, Taipei (TW)

(21) Appl. No.: 17/453,004

(22) Filed: Nov. 1, 2021

(30) Foreign Application Priority Data
Sep. 17, 2021 (TW) 110134998

(51) Int. Cl. G06F 16/332; G06F 40/295; G06F 16/33; G06F 16/35

(52) U.S. Cl. CPC G06F 16/3329; G06F 40/295; G06F 16/3347; G06F 16/35

(57) ABSTRACT

A machine reading comprehension apparatus and method are provided. The apparatus receives a question and a text. The apparatus generates a plurality of first predicted answers and a plurality of first source sentences corresponding to each of the first predicted answers according to the question, the text, and the machine reading comprehension model. The apparatus determines a question category of the question. The apparatus extracts a plurality of special terms related to the question category and a plurality of second source sentences corresponding to each of the special terms from the text. The apparatus concatenates the question, the first source sentences, the second source sentences, the first predicted answers, and the special terms into an extended string. The apparatus generates a plurality of second predicted answers corresponding to the question according to the extended string and the micro finder model.

### CROSS-REFERENCE TO RELATED APPLICATION

This application claims priority to Taiwan Application Serial Number 110134998, filed Sep. 17, 2021, which is herein incorporated by reference in its entirety.

### BACKGROUND

### Field of Invention

The present invention relates to a machine reading comprehension apparatus and method. More particularly, the present invention relates to a machine reading comprehension apparatus and method for improving the accuracy of machine reading comprehension based on a multi-stage adjustment mechanism.

### Description of Related Art

In recent years, the application of conversational artificial intelligence in the field has become more and more extensive, and the Machine Reading Comprehension (MRC) technology is a very important technology in the conversational artificial intelligence.

In the scenario of machine reading comprehension applications, the user can ask a question to be answered related to a text (e.g., a certain article), and the machine can automatically read and understand the content of the text and generate a predicted answer corresponding to the question. Specifically, in traditional machine reading comprehension technology, a large amount of training data is generally used to train a machine reading comprehension model so that the machine reading comprehension model can extract part of the content from the text as the predicted answer responding to the question.

However, in the traditional machine reading comprehension technology, the predicted answer generated by the machine often deviates from the actual correct answer (i.e., the start position and end position of the predicted answer are not the same as the start position and end position of the actual correct answer), resulting in an incomplete answer or even an incorrect answer.

For example, a text about “Little Goguryeo” contains a narrative that “The author of ‘The Study of Little Goguryeo’ is Hino Kaisaburo”. The user proposed a question to be answered that “Who is the author of ‘The Study of Little Goguryeo’ ?”. In traditional machine reading comprehension technology, after the machine reads and understands the text, the predicted answer may be generated only as “Kaisaburo”. However, for the question proposed by the user, the complete and correct answer should be “Hino Kaisaburo” instead of only “Kaisaburo”. Obviously, the traditional machine reading comprehension technology only extracts part of the answers in the text, resulting in incomplete answers, or even incorrect answers.

In addition, the traditional machine reading comprehension technology also lacks determination on specific proper nouns (e.g., specific terms) in a specific field, so it is difficult to correctly generate answers that include specific proper nouns in a particular field.

Accordingly, there is an urgent need for a technology that can improve the accuracy of machine reading comprehension.

### SUMMARY

An objective of the present invention is to provide a machine reading comprehension apparatus. The machine reading comprehension apparatus comprises a storage, a transceiver interface, and a processor, and the processor is electrically connected to the storage and the transceiver interface. The storage stores a machine reading comprehension model and a micro finder model. The processor receives a question and a text through the transceiver interface. The processor generates a plurality of first predicted answers and a plurality of first source sentences corresponding to each of the first predicted answers according to the question, the text, and the machine reading comprehension model. The processor determines a question category of the question. The processor extracts a plurality of special terms related to the question category and a plurality of second source sentences corresponding to each of the special terms from the text. The processor concatenates the question, the first source sentences, the second source sentences, the first predicted answers, and the special terms into an extended string. The processor generates a plurality of second predicted answers corresponding to the question according to the extended string and the micro finder model.

Another objective of the present invention is to provide a machine reading comprehension method, which is adapted for use in an electronic apparatus. The electronic apparatus comprises a storage, a transceiver interface and a processor. The storage stores a machine reading comprehension model and a micro finder model. The machine reading comprehension method is performed by the processor. The machine reading comprehension method comprises following steps: receiving a question and a text though the transceiver interface; generating a plurality of first predicted answers and a plurality of first source sentences corresponding to each of the first predicted answers according to the question, the text, and the machine reading comprehension model; determining a question category of the question; extracting a plurality of special terms related to the question category and a plurality of second source sentences corresponding to each of the special terms from the text; concatenating the question, the first source sentences, the second source sentences, the first predicted answers, and the special terms into an extended string; and generating a plurality of second predicted answers corresponding to the question according to the extended string and the micro finder model.

According to the above descriptions, the machine reading comprehension technology (at least including the apparatus and the method) provided by the present invention generates a plurality of first predicted answers and a plurality of first source sentences corresponding to each of the first predicted answers according to the question, the text, and the machine reading comprehension model at the machine reading comprehension stage. At the answer enhancement feature construction stage, the machine reading comprehension technology determines a question category of the question, extracts a plurality of special terms related to the question category and a plurality of second source sentences corresponding to each of the special terms from the text, and concatenates the question, the first source sentences, the second source sentences, the first predicted answers, and the special terms into an extended string. At the micro finder stage, the machine reading comprehension technology generates a plurality of second predicted answers corresponding to the question according to the extended string and the micro finder model. The machine reading comprehension technology provided by the present invention improves the accuracy of machine reading comprehension, and solves the problem that the predicted answer generated by the conventional technology may produce incomplete answers. In addition, the present invention also determines specific proper nouns in a specific field, and solves the problem that it is difficult for the conventional technology to correctly generate answers of the question that include the specific proper nouns in the specific field.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a machine reading comprehension apparatus of the first embodiment;

FIG. 2A is a schematic view depicting the string distribution position of the extended string of the first embodiment;

FIG. 2B is a schematic view depicting the encoding vector position of the extended string after the encoding operation of the first embodiment;

FIG. 3 is a schematic view depicting the hot zone of the first embodiment; and

FIG. 4 is a partial flowchart depicting a machine reading comprehension method of the second embodiment.

### DETAILED DESCRIPTION

In the following description, a machine reading comprehension apparatus and method according to the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It shall be appreciated that, in the following embodiments and the attached drawings, elements unrelated to the present invention are omitted from depiction. In addition, dimensions of individual elements and dimensional relationships among individual elements in the attached drawings are provided only for illustration but not to limit the scope of the present invention.

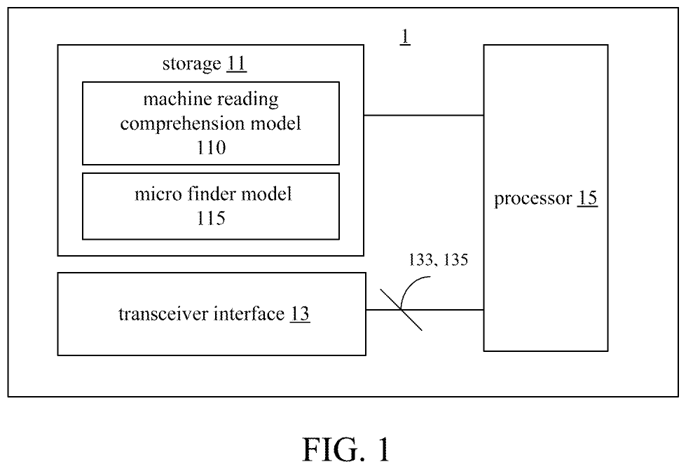

A first embodiment of the present invention is a machine reading comprehension apparatus 1 and a schematic view of which is depicted in FIG. 1. The machine reading comprehension apparatus 1 comprises a storage 11, a transceiver interface 13 and a processor 15, wherein the processor 15 is electrically connected to the storage 11 and the transceiver interface 13. The storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external apparatuses, external web pages, external applications, and so on. The processor 15 may be any of various processors, Central Processing Units (CPUs), microprocessors, digital signal processors or other computing apparatuses known to those of ordinary skill in the art.

In the present embodiment, as shown in FIG. 1, the storage 11 stores a machine reading comprehension model 110 and a micro finder model 115. It shall be appreciated that, in the present embodiment, the machine reading comprehension apparatus 1 first generates a preliminary predicted answer through the machine reading comprehension model 110, and then using the micro inquiry model 115 to adjust the preliminary predicted answer. The following paragraphs describe the specific implementation content of the machine reading comprehension model 110 first, and the specific implementation content of the micro finder model 115 will be detailed later.

Specifically, the machine reading comprehension model 110 is a trained language model, and the trained machine reading comprehension model 110 can generate a predicted answer based on the question and the text. It shall be appreciated that the machine reading comprehension model 110 may be directly received by the machine reading comprehension apparatus 1 from an external apparatus, or trained by the machine reading comprehension apparatus 1 itself.

In some embodiments, the operations of training the machine reading comprehension model can be based on a language model (e.g., the language model BERT (Bidirectional Encoder Representations from Transformers) proposed by Google), further perform the training based on a large number of manually labeled input data (e.g., text, artificially designed questions and correct answers), perform machine learning through an architecture such as Neural Network, and perform fine-tuning operation to the language model to generate the trained machine reading comprehension model. Those of ordinary skill in the art shall appreciate how to perform the machine learning through the Neural Network architecture based on the foregoing descriptions. Therefore, the details will not be repeated herein.

First, the operation of the first embodiment of the present invention will be briefly explained. The present invention is mainly divided into three stages, namely the machine reading comprehension stage, the answer enhancement feature construction stage and the micro finder stage, the following paragraphs will detail the implementation details related to the present invention.

First, in the machine reading and comprehension stage, as shown in FIG. 1, the processor 15 receives the question 133 and the text 135 through the transceiver interface 13. Next, the processor 15 generates a plurality of first predicted answers and a plurality of first source sentences (i.e., span sentences) corresponding to each of the first predicted answers according to the question 133, the text 135 and the machine reading comprehension model 110. It shall be appreciated that the first source sentence is the sentence source of the first predicted answer in the text 135 (i.e., the machine reading comprehension model 110 generates the first predicted answer based on the first source sentence).

For example, the text 135 includes the descriptions “The Japanese scholar Hino Kaisaburo described in his book ‘Study of the Little Goguryeo Kingdom’ that after the demise of Goguryeo, the descendants of the Goguryeo royal family established a rejuvenating regime in Liaodong and north of Datong River on the Korean Peninsula ‘Little Goguryeo’”. The question 133 is “Who is the author of ‘The Study of Little Goguryeo’ ?”. In this example, the machine reading comprehension model 110 determines that the first predicted answer is “Kisaburo” based on the sentence in the text 135 “The Japanese scholar Hino Kaisaburo described in his book ‘Study of the Little Goguryeo Kingdom’ that after the demise of Goguryeo”. Therefore, “The Japanese scholar Hino Kaisaburo described in his book ‘Study of the Little Goguryeo Kingdom’ that after the demise of Goguryeo” is the first source sentence.

It shall be appreciated that, in some embodiments, the machine reading comprehension model 110 may generate a plurality of first predicted answers with a ranking order (e.g., ranking based on confidence) and the corresponding first source sentence, and only select part of the first predicted answers and corresponding first source sentences for subsequent operations (e.g., only the top two predicted answers and the corresponding first source sentences are selected). The mechanism can be adjusted or set by the machine reading comprehension apparatus 1 based on the scale and needs.

Next, the following paragraphs will explain the answer enhancement feature construction stage. It shall be appreciated that the answer enhancement feature construction stage is divided into a special terms extraction stage and a concatenating extended string stage. The following paragraphs will describe the implementation details related to the present invention.

First, in the special terms extraction stage, in order to more accurately extract possible complete answers (e.g., proper nouns or special terms in a specific field) from the text 135, the processor 15 analyzes the question 133 based on the question category, and extracts the specific terms corresponding to the question category from the text 135 based on the question category. Specifically, the processor 15 determines a question category of the question 133. Then, the processor 15 extracts a plurality of special terms related to the question category and a plurality of second source sentences corresponding to each of the special terms from the text 135.

It shall be appreciated that, in different embodiments, the machine reading comprehension apparatus 1 can adjust the items and number of the question category corresponding to the question based on the text 135. In some embodiments, the machine reading comprehension apparatus 1 can classify the question into four question categories: “Who”, “Where”, “When”, and “Other”. For example, based on the aforementioned four question categories, the processor 15 determines that the question 133 “Who is the author of ‘Study on Little Goguryeo’ ?” is belongs to the question category of “who”.

In some embodiments, determining the question category of the question 133 can be accomplished by a question classification model that has been trained. It shall be appreciated that the question classification model is trained through a large amount of artificially labeled input data, and machine learning is performed through the neural network architecture. Those of ordinary skill in the art shall appreciate the operations of performing the machine learning through the Neural Network architecture based on the foregoing descriptions. Therefore, the details will not be repeated herein.

In some embodiments, the processor 15 analyzes the text 135 to generate a plurality of entity classifications, the special terms corresponding to each of the entity classifications, and a plurality of second sources sentences corresponding to each of the special terms. Then, the processor 15 extracts the special terms related to the question category and the second source sentences corresponding to each of the special terms according to the question category and the entity classification. Specifically, the processor 15 can use, for example, a Named Entity Recognition (NER) model, a keyword comparison algorithm, and a special terms extraction algorithm for the aforementioned operations of generating entity classifications, special terms, and second source sentences.

For ease of understanding, a specific example will be used as an example below. In this example, the text 135 includes the descriptions “The Japanese scholar Hino Kaisaburo described in his book ‘Study of the Little Goguryeo Kingdom’ that after the demise of Goguryeo, the descendants of the Goguryeo royal family established a rejuvenating regime in Liaodong and north of Datong River on the Korean Peninsula ‘Little Goguryeo”’, the question 133 is “Who is the author of ‘The Study of Little Goguryeo’ ?” (which has been classified into the question category of “Who”).

As shown in Table 1 below, after the processor 15 analyzes the text 135, and generates entity classifications such as “person's name”, “geographical nouns”, and “national organization”, as well as the special term “Nino Kaisaburo” corresponding to “person's name”, the special terms “Liaodong” and “Korean Peninsula” corresponding to “geographical nouns”, and the special terms “Japan”, “Goguryeo” and “Little Goguryeo” corresponding to the “national organization”. In addition, as shown in Table 2 below, the processor 15 also generates a plurality of second source sentences corresponding to “Nino Kaisaburo”, “Liaodong”, “Korean Peninsula”, “Japan”, “Goguryeo” and “Little Goguryeo”.

TABLE 1

| entity classifications | special terms |
|---|---|
| person's name | “Hino Kaisaburo” |
| geographical nouns | “Liaodong”, “Korean Peninsula” |
| national organization | “Japan”, “Goguryeo”, “Little Goguryeo” |

TABLE 2

| special terms | second source sentences |
|---|---|
| “Hino Kaisaburo” | “The Japanese scholar Hino Kaisaburo described |
| | in his book ‘Study of the Little Goguryeo Kingdom’ |
| | that after the demise of Goguryeo” |
| “Liaodong” | “the descendants of the Goguryeo royal family |
| | established a rejuvenating regime in Liaodong |
| | and north of Datong River on the Korean |
| | Peninsula ‘Little Goguryeo’” |
| “Korean Peninsula” | “the descendants of the Goguryeo royal family |
| | established a rejuvenating regime in Liaodong |
| | and north of Datong River on the Korean |
| | Peninsula ‘Little Goguryeo’” |
| “Japan” | “The Japanese scholar Hino Kaisaburo described |
| | in his book ‘Study of the Little Goguryeo Kingdom’ |
| | that after the demise of Goguryeo” |
| “Goguryeo” | “The Japanese scholar Hino Kaisaburo described |
| | in his book ‘Study of the Little Goguryeo Kingdom’ |
| | that after the demise of Goguryeo” |
| “Little Goguryeo” | “The Japanese scholar Hino Kaisaburo described |
| | in his book ‘Study of the Little Goguryeo Kingdom’ |
| | that after the demise of Goguryeo”, “the |
| | descendants of the Goguryeo royal family |
| | established a rejuvenating regime in Liaodong |
| | and north of Datong River on the Korean |
| | Peninsula ‘Little Goguryeo’” |

In this example, there is only the classification “person's name” in the entity classifications related to the question category of “who”. Therefore, the processor 15 extracts the special terms (i.e., “Nino Kaisaburo”) related to the question category (i.e., “who”) and the second source sentences corresponding to each of the special terms (i.e., “The Japanese scholar Hino Kaisaburo described in his book ‘Study of the Little Goguryeo Kingdom’ that after the demise of Goguryeo”).

It shall be appreciated that Table 1 and Table 2 are only used to illustrate the content of this example, and they are not used to limit the scope of the present invention. Those of ordinary skill in the art shall appreciate the operations of other embodiments (e.g., the text with more content) based on the foregoing descriptions. Therefore, the details will not be repeated herein.

Next, the operations of the concatenating extended string stage will be described below. In the concatenating extended string stage, the processor 15 further concatenates the features generated in the foregoing operations into an extended string to serve as an answer enhancement feature for subsequent input to the micro finder model 115. Specifically, the processor 15 concatenates the question 133, the first source sentences, the second source sentences, the first predicted answers, and the special terms into an extended string 200.

In some embodiments, when the processor 15 concatenates the extended string 200, the processor 15 concatenates a source sentence string in the extended string based on an order of the first source sentences and the second source sentences appearing in the text 135. In addition, when there exists a duplicate sentence in the source sentence string, the processor 15 deletes the duplicate sentence (i.e., deletes the duplicate source sentence). In other words, the processor 15 takes the union of the source sentences and concatenates the source sentences based on the order of the source sentences appearing in the text 135.

In some embodiments, before the processor 15 inputs the extended string 200 to the micro finder model 115, the processor 15 performs an encoding operation on the extended string 200 to facilitate the calculation in the subsequent micro inquiry stage, using the position of each character as the unit. Specifically, the processor 15 further performing an encoding operation on the extended string to generate a plurality of encoding vectors based on an encoding length of single character (e.g., each single character is a character unit). Finally, the processor 15 inputs the encoding vectors to the micro finder model 115.

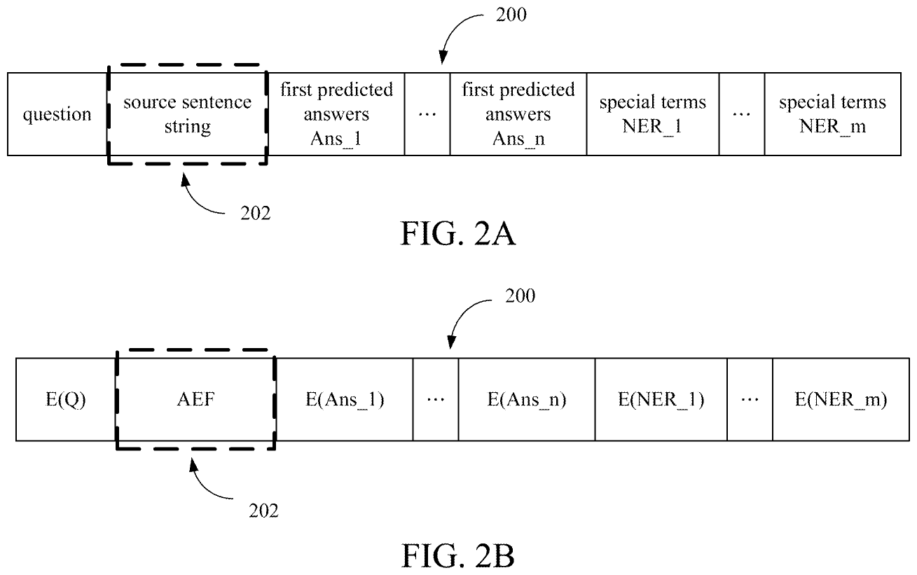

For ease of understanding, FIG. 2A shows a schematic view depicting the string distribution position of the extended string 200, and FIG. 2B shows a schematic view depicting the encoding vector position of the extended string 200 after the encoding operation. It shall be appreciated that the source sentence string 202 is generated by taking the union of the source sentences and concatenating the source sentences described above. Since the source sentence string 202 includes the first source sentence generated by the machine reading comprehension model 110 and the second source sentence related to the special terms, the source sentence string 202 includes the source of the sentence with a high probability of answering. The sentence string 202 is used as an answer enhancement feature (AEF) that is subsequently input to the micro finder model 115.

It shall be appreciated that the first predicted answer Ans_1, . . . , the first predicted answer Ans_n and the special terms NER_1, . . . , and the special terms NER_m respectively have their corresponding start index and end index in the source sentence string 202 (i.e, pointing to the start and end position of the character of the encoding vector respectively), the indices will be used in the calculation of the subsequent micro finder stage.

Next, the following paragraphs will explain the micro finder stage. In the micro finder stage, the machine reading comprehension apparatus 1 calculates the probability that each position of encoding vector in the source sentence string 202 is the start position or the end position based on the extended string 200 with the answer enhancement feature and the micro finder model 115, and determines a more accurate prediction answer based on the start-end pair probability vector. Specifically, the processor 15 generates a plurality of second predicted answers corresponding to the question 133 according to the extended string 200 and the micro finder model 115.

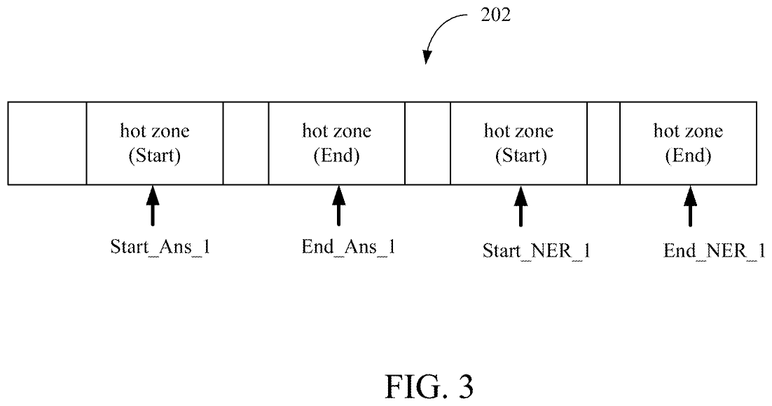

In some embodiments, the processor 15 further strengthens the weight of subsequent searches based on the start index or the end index in the first predicted answer or the special terms and the character offset (i.e., the numbers of characters (e.g., 2 characters) before and after the start index or the end index are regarded as the hot zone). Specifically, the processor 15 points a plurality of start indices and a plurality of end indices to a start position and an end position in each of the first predicted answers and each of the special terms in the encoding vectors, respectively. Then, the processor 15 generates a weight adjustment matrix based on the start indices, the end indices, and a character offset. For ease of understanding, as shown in FIG. 3, taking the first prediction answer Ans_1 and the special terms NER_1 as an example, the processor 15 sets the characters before and after the start index Start_Ans_1 and the end index End_Ans_1 of the first prediction answer Ans_1 as a hot zone, increase the searching weight of the hot zone. Similarly, the processor 15 sets the characters before and after the start index Start NER_1 and the end index End_NER_1 of the special terms NER_1 as the hot zone, and increase the searching weight of the hot zone.

For example, the processor 15 can generate the start weight adjustment matrix bₛ and the end adjustment matrix bₑ by using the following equation, taking the start weight adjustment matrix bₛ as an example:

$${b}_{s} = [ \begin{matrix}{b}_{{s}_{1}} & 0 \\ {b}_{{s}_{2}} & 0 \\ ⋮ & ⋮ \\ {b}_{{s}_{l}} & 0\end{matrix} ] , {b}_{{s}_{i}} = \{ \begin{matrix}α & if i in hot zone \\ 0 & otherwise\end{matrix}$$

In the above equation, the parameters bₛ₁, . . . , bₛₗ represent the weight value of each position of encoding vector in the source sentence string 202, and the parameter α represents an adjusted weight value when located in the hot zone.

Next, the processor 15 calculates a start index probability matrix and an end index probability matrix based on the encoding vectors and the weight adjustment matrix. For example, the processor 15 may use the following equation to generate the start index probability matrix Pₛ:

$${P}_{s} = {softmax}_{each row} ( E ( S ) {W}_{s} + {b}_{s} ) = [ \begin{matrix}{p}_{{sy}_{1}} & {p}_{{sn}_{1}} \\ {p}_{{sy}_{2}} & {p}_{{sn}_{2}} \\ ⋮ & ⋮ \\ {p}_{{sy}_{l}} & {p}_{{sn}_{l}}\end{matrix} ]$$

In the above equation, the parameters p_{sy1} . . . p_{syl} represent the probability that each position of encoding vector in the source sentence string 202 is the start index, the parameters pₛₙ₁, . . . , pₛₙₗ represent the probability that each position of encoding vector in the source sentence string 202 is not the start index. The parameter Wₛ is a start weight value generated by the micro finder model 115 after training by the neural network.

For example, the processor 15 may use the following equation to generate the end index probability matrix Pₑ:

$${P}_{e} = {softmax}_{each row} ( E ( S ) {W}_{e} + {b}_{e} ) = [ \begin{matrix}{p}_{{ey}_{1}} & {p}_{{en}_{1}} \\ {p}_{{ey}_{2}} & {p}_{{en}_{2}} \\ ⋮ & ⋮ \\ {p}_{{ey}_{l}} & {p}_{{en}_{l}}\end{matrix} ]$$

In the above equation, the parameters p_{ey1}, . . . , p_{eyl} represent the probability that each position of encoding vector in the source sentence string 202 is the end index, the parameters pₑₙ₁, . . . , pₑₙₗ represent the probability that each position of encoding vector in the source sentence string 202 is not the end index. The parameter Wₑ is an end weight value generated by the micro finder model 115 after training by the neural network.

Next, the processor 15 determines a high probability start index set and a high probability end index set based on the start index probability matrix Pₛ and the end index probability matrix Pₑ. For example, the processor 15 may determine a high probability start index set Iₛ and a high probability end index set Iₑ using the following equation:

I_{S}={i|p_{sy}_{ᵢ}−pₛₙ_{ᵢ}>∈,1≤i≤l}

Iₑ={j|p_{ey}_{ⱼ}−pₑₙ_{ⱼ}>∈,1≤j≤l}

In the above equation, if the condition satisfies p_{syi}−pₛₙᵢ>∈, it is considered that the start index i has a high probability of being a true start index, and the start index i will be added to the high probability start index set Iₛ. If the condition satisfies p_{eyj}−pₑₙⱼ>∈, it is considered that the end index j has a high probability of being a true end index, and the end index j will be added to the high probability end index set Iₑ. For example, the parameter E can be set to 0.2.

Next, the processor 15 generates a start-end pair probability vector based on the high probability start index set and the high probability end index set. For example, the processor 15 can generate the start-end pair probability vector Pₛₑ using the following equation:

Pₛₑ=sigmoid((E(sᵢ)⊕(eⱼ))Wₛₑ)∈ [symbol] ^{k×1}

In the above equation, sigmoid is a common activation function using in the deep learning, and the parameter Wₛₑ is a start-end weight value generated by the micro finder model 115 after training by the neural network. The symbol ⊕ is the concatenation symbol of two vectors. Specifically, the start-end pair probability vector represents the probability that each start-end pairing is the correct answer.

Finally, the processor 15 generates the second predicted answers corresponding to the question based on the start-end pair probability vector. For example, the processor 15 may use the following equation to generate the start-end pair probability vector:

P={(î,ĵ)|∀î∈Iₛ,∀ĵ∈Iₑ,î<ĵ,ĵ−î<ψ},k=|P|,∀(i,j)∈P

Specifically, the processor 15 excludes the situation where the end index position is earlier than the start index position, and filters the pairing results that are too far away based on ψ(e.g., ψ is usually set to 10).

In some embodiments, the micro finder model 115 is trained by a large amount of artificially labeled input data, and is generated after performing the machine learning through the neural network architecture. Specifically, the processor 15 calculates a correct start index, a correct end index and a correct pair result of each standard answer based on a plurality of testing texts, a plurality of testing questions, and the standard answer corresponding to each of the test questions. Next, the processor 15 establishes the correct start indices, the correct end indices, and a plurality of associated weights of the correct pair results through machine learning. Finally, the processor 15 establishes the micro finder model 115 based on the associated weights based on these correlation weights. For example, the processor 15 may use the following equation to generate the objective function:

λ=δ₁CE(Pₛ,Yₛ)+δ₂CE(Pₑ,Yₑ)+δ₃CE(Pₛₑ,Yₛₑ)

In the above equation, the parameters δ₁, δ₂, and δ₃ are weight values ranging from 0 to 1 (e.g., the parameters δ₁, δ₂, and δ₃ are usually be set to ⅓). The function CE is the Cross Entropy Loss function, which allows the model to learn the probability distribution of the predicted data. The parameters Yₛ, Yₑ, and Yₛₑ are the actual start index, end index, and start-end pairing respectively. The processor 15 trains through a large amount of input data to obtain the associated weights Wₛ, Wₑ, and Wₛₑ. Those of ordinary skill in the art shall appreciate the operations of performing the machine learning through the Neural Network architecture based on the foregoing descriptions. Therefore, the details will not be repeated herein.

According to the above descriptions, the machine reading comprehension apparatus 1 provided by the present invention, generating a plurality of first predicted answers and a plurality of first source sentences corresponding to each of the first predicted answers according to the question, the text, and the machine reading comprehension model at the machine reading comprehension stage. At the answer enhancement feature construction stage, the machine reading comprehension apparatus 1 determines a question category of the question, extracts a plurality of special terms related to the question category and a plurality of second source sentences corresponding to each of the special terms from the text, and concatenates the question, the first source sentences, the second source sentences, the first predicted answers, and the special terms into an extended string. At the micro finder stage, the machine reading comprehension apparatus 1 generates a plurality of second predicted answers corresponding to the question according to the extended string and the micro finder model. The machine reading comprehension technology provided by the present invention improves the accuracy of machine reading comprehension, and solves the problem that the predicted answer generated by the conventional technology may produce incomplete answers. In addition, the present invention also determines specific proper nouns in a specific field, and solves the problem that it is difficult for the conventional technology to correctly generate answers of the question that include the specific proper nouns in the specific field.

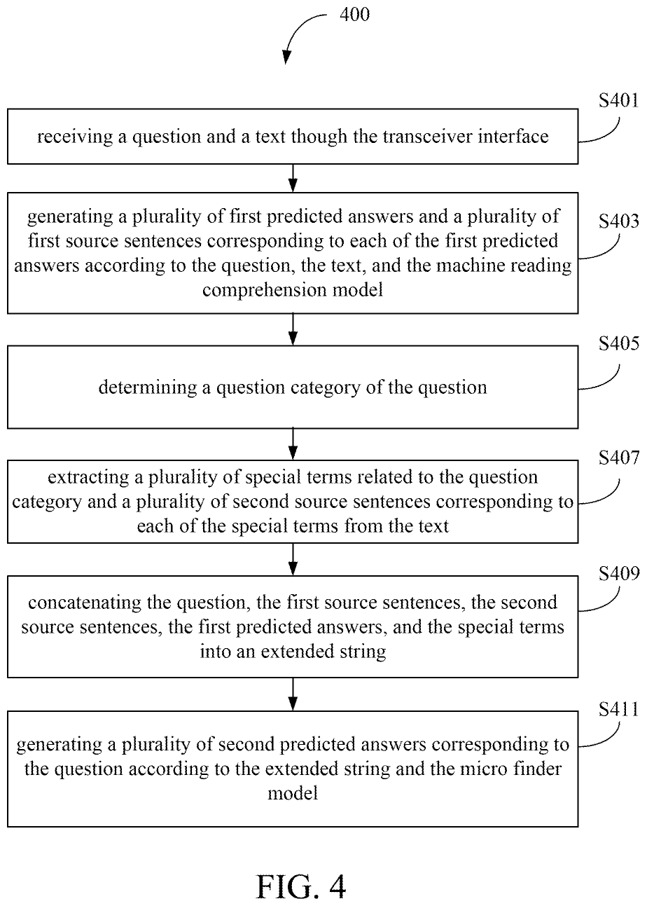

A second embodiment of the present invention is a machine reading comprehension method and a flowchart thereof is depicted in FIG. 4. The machine reading comprehension method 400 is adapted for an electronic apparatus (e.g., the machine reading comprehension apparatus 1 of the first embodiment), and the electronic apparatus comprises a storage, a transceiver interface and a processor. The electronic apparatus stores a machine reading comprehension model and a micro finder model, such as the machine reading comprehension model 110 and the micro finder model 115 in the first embodiment. The machine reading comprehension method generates a plurality of second predicted answers corresponding to the question through the steps S401 to S411.

In the step S401, the electronic apparatus receives a question and a text though the transceiver interface. In the step S403, the electronic apparatus determines a plurality of first predicted answers and a plurality of first source sentences corresponding to each of the first predicted answers according to the question, the text, and the machine reading comprehension model.

In the step S405, the electronic apparatus determines a question category of the question. In the step S407, the electronic apparatus extracts a plurality of special terms related to the question category and a plurality of second source sentences corresponding to each of the special terms from the text. Next, in the step S409, the electronic apparatus concatenates the question, the first source sentences, the second source sentences, the first predicted answers, and the special terms into an extended string.

Finally, in the step S411, the electronic apparatus generates a plurality of second predicted answers corresponding to the question according to the extended string and the micro finder model.

In some embodiments, the machine reading comprehension method 400 further comprises following steps: analyzing the text to generate a plurality of entity classifications, the special terms corresponding to each of the entity classifications, and a plurality of second source sentences corresponding to each of the special terms; and extracting the special terms related to the question category and the second source sentences corresponding to each of the special terms according to the question category and the entity classifications.

In some embodiments, the machine reading comprehension method 400 further comprises following steps: when concatenating the extended string: concatenating a source sentence string in the extended string based on an order of the first source sentences and the second source sentences appearing in the text; and deleting a duplicate sentence when the duplicate sentence exists in the source sentence string.

In some embodiments, the machine reading comprehension method 400 further comprises following steps: performing an encoding operation on the extended string to generate a plurality of encoding vectors based on an encoding length of single character; and inputting the encoding vectors to the micro finder model.

In some embodiments, the machine reading comprehension method 400 further comprises following steps: pointing a plurality of start indices and a plurality of end indices to a start position and an end position in each of the first predicted answers and each of the special terms in the encoding vectors; generating a weight adjustment matrix based on the start indices, the end indices, and a character offset; calculating a start index probability matrix and an end index probability matrix based on the encoding vectors and the weight adjustment matrix; determining a high probability start index set and a high probability end index set based on the start index probability matrix and the end index probability matrix; generating a start-end pair probability vector based on the high probability start index set and the high probability end index set; and generating the second predicted answers corresponding to the question based on the start-end pair probability vector.

In some embodiments, the machine reading comprehension method 400 further comprises following steps: calculating a correct start index, a correct end index and a correct pair result of each standard answer based on a plurality of testing texts, a plurality of testing questions, and the standard answer corresponding to each of the test questions; establishing the correct start indices, the correct end indices, and a plurality of associated weights of the correct pair results through machine learning; and establishing the micro finder model based on the associated weights.

In addition to the aforesaid steps, the second embodiment can also execute all the operations and steps of the machine reading comprehension apparatus 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., predicted answers and source sentences) are preceded by terms such as “first” or “second,” and these terms of “first” and “second” are only used to distinguish these different words. For example, the “first” and “second” in the first source sentences and the second source sentences are only used to indicate the source sentences used in different stages.

According to the above descriptions, the machine reading comprehension technology (at least including the apparatus and the method) provided by the present invention generates a plurality of first predicted answers and a plurality of first source sentences corresponding to each of the first predicted answers according to the question, the text, and the machine reading comprehension model at the machine reading comprehension stage. At the answer enhancement feature construction stage, the machine reading comprehension technology determines a question category of the question, extracts a plurality of special terms related to the question category and a plurality of second source sentences corresponding to each of the special terms from the text, and concatenates the question, the first source sentences, the second source sentences, the first predicted answers, and the special terms into an extended string. At the micro finder stage, the machine reading comprehension technology generates a plurality of second predicted answers corresponding to the question according to the extended string and the micro finder model. The machine reading comprehension technology provided by the present invention improves the accuracy of machine reading comprehension, and solves the problem that the predicted answer generated by the conventional technology may produce incomplete answers. In addition, the present invention also determines specific proper nouns in a specific field, and solves the problem that it is difficult for the conventional technology to correctly generate answers of the question that include the specific proper nouns in the specific field.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A machine reading comprehension apparatus, comprising:
a storage, storing a machine reading comprehension model and a micro finder model;
a transceiver interface; and
a processor, being electrically connected to the storage and the transceiver interface, and being configured to perform following operations:
receiving a question and a text through the transceiver interface;
generating a plurality of first predicted answers and a plurality of first source sentences corresponding to each of the first predicted answers according to the question, the text, and the machine reading comprehension model;
determining a question category of the question;
extracting a plurality of special terms related to the question category and a plurality of second source sentences corresponding to each of the special terms from the text;
concatenating the question, the first source sentences, the second source sentences, the first predicted answers, and the special terms into an extended string; and
generating a plurality of second predicted answers corresponding to the question according to the extended string and the micro finder model.

2. The machine reading comprehension apparatus of claim 1, wherein the processor further comprises the following operations:
analyzing the text to generate a plurality of entity classifications, the special terms corresponding to each of the entity classifications, and a plurality of second source sentences corresponding to each of the special terms; and
extracting the special terms related to the question category and the second source sentences corresponding to each of the special terms according to the question category and the entity classifications.

3. The machine reading comprehension apparatus of claim 1, wherein the processor further comprises the following operations when concatenating the extended string:
concatenating a source sentence string in the extended string based on an order of the first source sentences and the second source sentences appearing in the text; and
deleting a duplicate sentence when the duplicate sentence exists in the source sentence string.

4. The machine reading comprehension apparatus of claim 1, wherein the processor further comprises the following operations:
performing an encoding operation on the extended string to generate a plurality of encoding vectors based on an encoding length of single character; and
inputting the encoding vectors to the micro finder model.

5. The machine reading comprehension apparatus of claim 4, wherein the processor further comprises the following operations:
pointing a plurality of start indices and a plurality of end indices to a start position and an end position in each of the first predicted answers and each of the special terms in the encoding vectors;
generating a weight adjustment matrix based on the start indices, the end indices, and a character offset;
calculating a start index probability matrix and an end index probability matrix based on the encoding vectors and the weight adjustment matrix;
determining a high probability start index set and a high probability end index set based on the start index probability matrix and the end index probability matrix;
generating a start-end pair probability vector based on the high probability start index set and the high probability end index set; and
generating the second predicted answers corresponding to the question based on the start-end pair probability vector.

6. The machine reading comprehension apparatus of claim 1, wherein the processor further comprises the following operations:
calculating a correct start index, a correct end index and a correct pair result of each standard answer based on a plurality of testing texts, a plurality of testing questions, and the standard answer corresponding to each of the test questions;
establishing the correct start indices, the correct end indices, and a plurality of associated weights of the correct pair results through machine learning; and
establishing the micro finder model based on the associated weights.

7. A machine reading comprehension method, being adapted for use in an electronic apparatus, comprising a storage, a transceiver interface and a processor, the storage storing a machine reading comprehension model and a micro finder model, the machine reading comprehension method being performed by the processor and comprising following steps:
receiving a question and a text though the transceiver interface;
generating a plurality of first predicted answers and a plurality of first source sentences corresponding to each of the first predicted answers according to the question, the text, and the machine reading comprehension model;
determining a question category of the question;
extracting a plurality of special terms related to the question category and a plurality of second source sentences corresponding to each of the special terms from the text;
concatenating the question, the first source sentences, the second source sentences, the first predicted answers, and the special terms into an extended string; and
generating a plurality of second predicted answers corresponding to the question according to the extended string and the micro finder model.

8. The machine reading comprehension method of claim 7, wherein the machine reading comprehension method further comprises following steps:
analyzing the text to generate a plurality of entity classifications, the special terms corresponding to each of the entity classifications, and a plurality of second source sentences corresponding to each of the special terms; and
extracting the special terms related to the question category and the second source sentences corresponding to each of the special terms according to the question category and the entity classifications.

9. The machine reading comprehension method of claim 7, wherein the machine reading comprehension method further comprises following steps when concatenating the extended string:
concatenating a source sentence string in the extended string based on an order of the first source sentences and the second source sentences appearing in the text; and
deleting a duplicate sentence when the duplicate sentence exists in the source sentence string.

10. The machine reading comprehension method of claim 7, wherein the machine reading comprehension method further comprises following steps:
performing an encoding operation on the extended string to generate a plurality of encoding vectors based on an encoding length of single character; and
inputting the encoding vectors to the micro finder model.

11. The machine reading comprehension method of claim 10, wherein the machine reading comprehension method further comprises following steps:
pointing a plurality of start indices and a plurality of end indices to a start position and an end position in each of the first predicted answers and each of the special terms in the encoding vectors;
generating a weight adjustment matrix based on the start indices, the end indices, and a character offset;
calculating a start index probability matrix and an end index probability matrix based on the encoding vectors and the weight adjustment matrix;
determining a high probability start index set and a high probability end index set based on the start index probability matrix and the end index probability matrix;
generating a start-end pair probability vector based on the high probability start index set and the high probability end index set; and
generating the second predicted answers corresponding to the question based on the start-end pair probability vector.

12. The machine reading comprehension method of claim 7, wherein the machine reading comprehension method further comprises following steps:
calculating a correct start index, a correct end index and a correct pair result of each standard answer based on a plurality of testing texts, a plurality of testing questions, and the standard answer corresponding to each of the test questions;
establishing the correct start indices, the correct end indices, and a plurality of associated weights of the correct pair results through machine learning; and
establishing the micro finder model based on the associated weights.
